(19) United States
(12) Patent Application Publication
(10) Pub. No.: US 2007/0126956 A1
(43) Pub. Date: Jun. 7, 2007

(54) Dual-cell gap transflective liquid crystal display device

(75) Inventors: Yi Chun Wu, Hualien City (TW); Chin Chang Liu, Fongyuan City (TW); Wen Jui Liao, Taiping City (TW); Chun Chi Chi, Longjing Township (TW)

Correspondence Address: LOWE HAUPTMAN BERNER, LLP, 1700 DIAGONAL ROAD, SUITE 300, ALEXANDRIA, VA, 22314, US

(73) Assignee: WINTEK CORPORATION, Taichung (TW)

(21) Appl. No.: 11/293,145

(22) Filed: Dec. 5, 2005

(51) Int. Cl. G02F 1/1335; G02F 1/1347

(52) U.S. Cl. 349/114; 349/74

(57) ABSTRACT

A dual-cell gap transflective LCD device comprises an upper substrate and a lower substrate, a liquid crystal layer interposed between the upper and lower substrates, a transmissive region and a reflective region, a first retardation plate disposed on the upper substrate, and a second retardation plate disposed on the lower substrate. The dual-cell gap transflective LCD device only utilizes two retardation plates, i.e. the first and second retardation plates, to compensate the phase difference of the light caused by the birefringence of the liquid crystal whereby obtaining a high contrast display in both the transmissive region and the reflective region.

### BACKGROUND OF THE INVENTION

1. Field of the Invention

This invention generally relates to a transflective LCD device, and more particularly to a dual-cell gap transflective LCD device.

2. Description of the Related Art

Generally, a transmissive liquid crystal display (LCD) device has advantages of high contrast ratio and good color saturation. However, the transmissive LCD device may suffer low image contrast when ambient light is bright. In addition, its power consumption is high due to the need of a backlight device. On the other hand, a reflective LCD device uses ambient light, instead of backlight, for displaying images; therefore, its power consumption is relatively low. However, the reflective LCD device is less visible when ambient light is dark.

In order to overcome the above-mentioned disadvantages of the transmissive and reflective LCD devices, a transflective LCD device is developed. The transflective LCD device can use both the back light and the ambient light, so that it can perform a clear display even in dark surroundings while reducing the power consumption. In general, the transflective LCD device includes two types, i.e. a single-cell gap transflective LCD device and a dual-cell gap transflective LCD device. In the single-cell gap transflective LCD device, the cell gaps for reflective and transmissive regions are the same. In the dual-cell gap transflective LCD device, the cell gaps for reflective and transmissive regions are different. In the following content, only the dual-cell gap transflective LCD device is discussed.

FIG. 1 is a cross-sectional view of a conventional dual-cell gap transflective LCD device 10. The dual-cell gap transflective LCD device 10 comprises an upper substrate 12, a lower substrate 14 and a liquid crystal layer 16 interposed therebetween. The lower substrate 14 includes a plurality of pixel regions (only one shown). Each pixel region further includes a transmissive region 18 and a reflective region 20. In addition, two cell gaps d1 and d2 are respectively formed at the transmissive region 18 and the reflective region 20 between the two substrates 12 and 14. The cell gap d1 is generally two times of the cell gap d2. An upper quarter wave plate 22, an upper half wave plate 24, and an upper polarization plate 26 are respectively disposed on the upper substrate 12. A lower quarter wave plate 28, a lower half wave plate 30, and a lower polarization plate 32 are respectively disposed on the lower substrate 14. The optical plates 22, 24, 28 and 30 are disposed for compensating the phase difference with respect to each red (R), green (G), and blue (B) light so as to reduce the color dispersion.

However, the dual-cell gap transflective LCD device 10 only has a reflection contrast ratio of about 10 and requires complicated processes to dispose the optical plates 22, 24, 26 and the optical plates 28, 30, 32 on the upper substrate 12 and the lower substrate 14, respectively. In addition, if the complicated processes are not appropriately performed, that is, if the optical plates 22, 24, 26, 28, 30 and 32 are not appropriately disposed on the upper and lower substrates 12 and 14, it may result in deteriorating LCD performance, such as variations in brightness and/or color. Further, the optical plates 22, 24, 26, 28, 30 and 32 will increase the whole thickness and the manufacturing cost of the dual-cell gap transflective LCD device 10.

### SUMMARY OF THE INVENTION

It is an object of the present invention to provide a dual-cell gap transflective LCD device, which can increase the reflection contrast ratio.

It is another object of the present invention to provide a dual-cell gap transflective LCD device, which can not only simplify the optical plate disposing processes but also reduce the whole thickness and the manufacturing cost.

In order to achieve the above objects, the dual-cell gap transflective LCD device of the present invention comprises two substrates, a liquid crystal layer interposed between the two substrates, a transmissive region and a reflective region, an upper polarization plate, a first retardation plate disposed between one of the substrates and the upper polarization plate, a lower polarization plate, and a second retardation plate disposed between the other one of the substrates and the lower polarization plate.

According to the dual-cell gap transflective LCD device of the present invention, only two retardation plates, i.e. the first and second retardation plates, are utilized such that the optical plate disposing processes are simplified, and the whole thickness and the manufacturing cost are reduced.

In the dual-cell gap transflective LCD device of the present invention, the liquid crystal layer has a phase delay value (Δnd) of 390 nm to 410 nm in the transmissive region, and a phase delay value (Δnd) of 260 nm to 280 nm in the reflective region. Further, the first retardation plate has a slow axis angle of 0° to 30° and a phase delay value (Δnd) of 150 nm to 450 nm, and the second retardation plate has a slow axis angle of 130° to 180° and a phase delay value (Δnd) of 200 nm to 250 nm.

In addition, the dual-cell gap transflective LCD device of the present invention can achieve a reflection contrast ratio greater than 16 by only utilizing the first and second retardation plates.

### BRIEF DESCRIPTION OF THE DRAWINGS

Other objects, advantages, and novel features of the present invention will become more apparent from the following detailed description when taken in conjunction with the accompanying drawings.

FIG. 1 is a cross-sectional view of a conventional dual-cell gap transflective LCD device.

FIG. 2 shows a cross-sectional view of a dual-cell gap transflective LCD device according to one embodiment of the present invention.

FIGS. 3 and 4 are simulation results of the reflectivity and transmittance, in relation to a voltage, of the transflective LCD device according to Example 1 of the present invention.

FIGS. 5 and 6 are simulation results of the reflectivity and transmittance, in relation to a voltage, of the transflective LCD device according to Example 2 of the present invention.

FIGS. 7 and 8 are simulation results of the reflectivity and transmittance, in relation to a voltage, of the transflective LCD device according to Example 3 of the present invention.

FIGS. 9 and 10 are simulation results of the reflectivity and transmittance, in relation to a voltage, of the transflective LCD device according to Example 4 of the present invention.

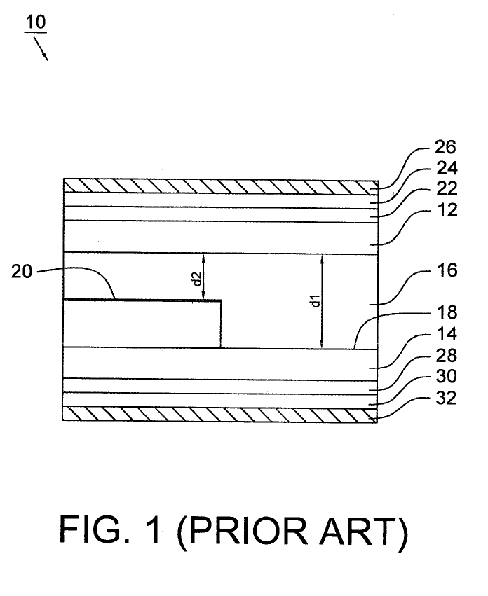

### DETAILED DESCRIPTION OF THE PREFERRED EMBODIMENT

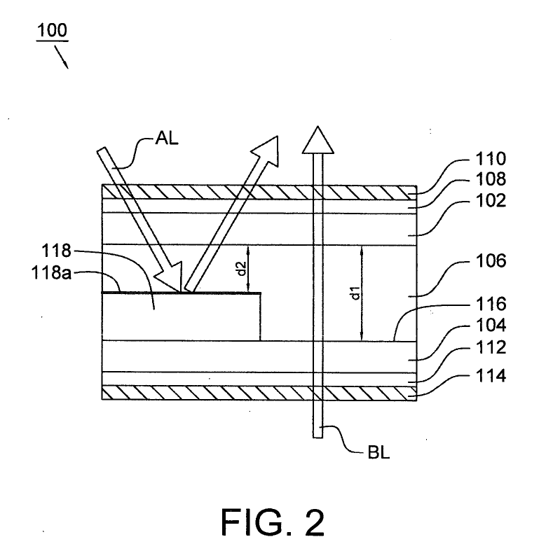

FIG. 2 shows a cross-sectional view of a dual-cell gap transflective LCD device 100 according to one embodiment of the present invention. The transflective LCD device 100 comprises an upper substrate 102, a lower substrate 104 and a liquid crystal layer 106 interposed between the upper substrates 102 and the lower substrate 104. The transflective LCD device 100 further comprises an upper retardation plate 108 disposed on the upper substrate 102, an upper polarization plate 110 disposed on the upper retardation plate 108, a lower retardation plate 112 disposed on the lower substrate 104, and a lower polarization plate 114 disposed on the lower retardation plate 112. The upper and lower polarization plates 110 and 114 can transform light into linearly polarized light. On the other hand, the upper and lower retardation plates 108 and 112 can transform linearly polarized light into elliptically polarized light or vice verse.

According to the embodiment of the present invention, each of the upper and lower retardation plates 108 and 112 can be any retardation plate having a specific slow axis angle and a specific phase delay value (Δnd), except for quarter wave plate. Any retardation plate, except for quarter wave plate, can be referred to as a non-quarter wave plate in the following content.

The lower substrate 104 includes a plurality of pixel regions (only one shown). Each pixel region includes a transmissive region 116 through which back light BL generated from a backlight device (not shown) can pass, and a reflective region 118 through which ambient light AL generated from surroundings can be reflected. The reflective region 118 has a reflective layer 118a formed thereon. In addition, two cell gaps d1 and d2 are respectively formed at the transmissive region 116 and the reflective region 118 between the upper substrate 102 and the lower substrate 104. The two cell gaps d1 and d2 are formed in order to compensate the unmatched liquid crystal retardation. According to the embodiment of the present invention, the cell gap d1 is not limited to two times of the cell gap d2.

The transflective LCD device 100 can display an image both in a transmission mode and a reflection mode. In the transmission mode, when the back light BL enters the lower substrate 104 and passes through the liquid crystal layer 106 at the transmissive region 116, it can be provided for display. On the other hand, in the reflection mode, when the ambient light AL is incident on the upper substrate 102 and passes through the liquid crystal layer 106, it is reflected by the reflective region 118 and then passes through the liquid crystal layer 106 again to be provided for display.

The transflective LCD device 100 according to the present invention can display an image with high contrast ratio and low color dispersion by optimizing the parameters of the optical elements, such as the twist angle and the phase delay value (Δnd) of the liquid crystal layer 106, the slow axis angles and the phase delay values (Δnd) of the upper and lower retardation plates 108 and 112, and the transmission axis angles of the upper and lower polarization plates 110 and 114. These optimized parameters will be described below.

According to the transflective LCD device 100 of the present invention, the liquid crystal layer 106 is formed of mixed-mode twisted nematic (MTN) liquid crystal having a twist angle of 50° to 80°. Further, the liquid crystal layer 106 has a phase delay value (Δnd) of 390 nm to 410 nm, preferably around 400 nm, in the transmissive region 116, and a phase delay value (Δnd) of 260 nm to 280 nm, preferably around 270 nm, in the reflective region 118. In addition, the upper retardation plate 108 has a slow axis angle of 0° to 30° and a phase delay value (Δnd) of 150 nm to 450 nm, and the lower retardation plate 112 has a slow axis angle of 130° to 180° and a phase delay value (Δnd) of 200 nm to 250 nm. The upper polarization plate 110 has a transmission axis angle of 0° to 120°, and the lower polarization plate 114 has a transmission axis angle of 20° to 180°.

The transflective LCD device 100 with the optimized parameters has been simulated by DiMOS (version1.5b), which is an optical simulation program and can be commercially obtained from autronic-MELCHERS GmbH. The simulation results show that the transflective LCD device 100 can display an image with high contrast ratio and low color dispersion. The simulated examples are described in the following:

### EXAMPLE 1

The simulation in this example calculates the reflectivity and transmittance, in relation to a voltage, of the transflective LCD device 100 in the reflection and transmission modes while the liquid crystal (LC) of the liquid crystal layer 106 has a twist angle of 50°, a phase delay value (Δnd) of 400 nm in the transmissive region 116, and a phase delay value (Δnd) of 270 nm in the reflective region 118. The simulation parameters are shown in Table 1.

TABLE 1
simulation parameters

| | Mode | |
|---|---|---|
| Parameters | Transmission Mode | Reflection Mode |
| Twist angle of LC | 50° | 50° |
| Δ nd of LC | 400 nm | 270 nm |
| slow axis angle of upper | 10° | 10° |
| retardation plate | | |
| Δ nd of upper retardation | 420 nm | 420 nm |
| plate | | |
| transmission axis angle of | 88° | 88° |
| upper polarization plate | | |
| slow axis angle of lower | 145° | N/A |
| retardation plate | | |
| Δ nd of lower retardation | 200 nm | N/A |
| plate | | |
| transmission axis angle of | 170° | N/A |
| lower polarization plate | | |

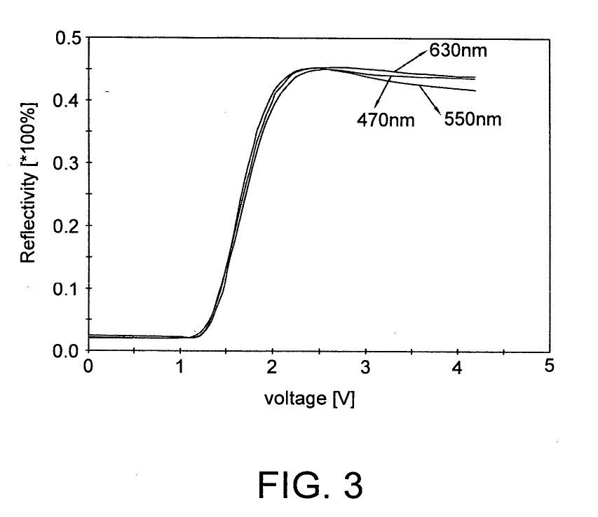

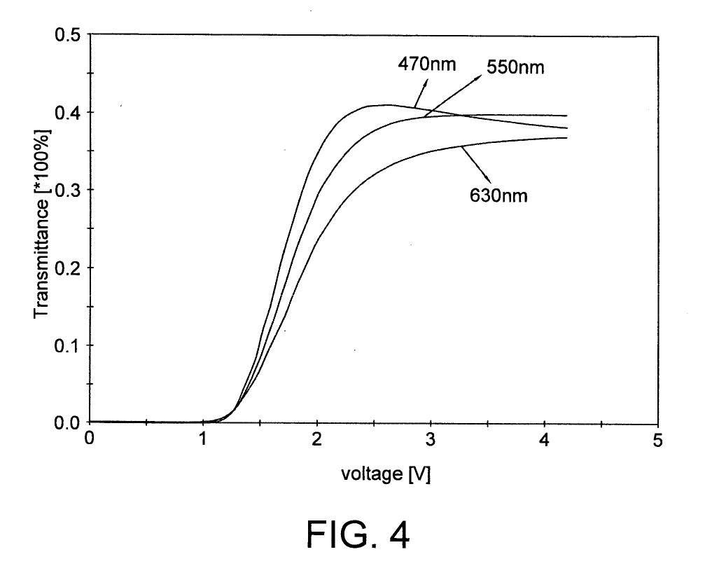

In this example, the reflectivity and transmittance of the transflective LCD device 100 at wavelengths 470 nm (Blue), 550 nm (Green) and 630 nm (Red) are calculated and shown in FIG. 3 and FIG. 4, respectively. In addition, the transmission contrast ratio is calculated as 483.5, and the reflection contrast ratio is calculated as 18.53.

### EXAMPLE 2

The simulation in this example calculates the reflectivity and transmittance, in relation to a voltage, of the transflective LCD device 100 in the reflection and transmission modes while the liquid crystal (LC) of the liquid crystal layer 106 has a twist angle of 60°, a phase delay value (Δnd) of 400 nm in the transmissive region 116, and a phase delay value (Δnd) of 270 nm in the reflective region 118. The simulation parameters are shown in Table 2.

TABLE 2
simulation parameters

Mode

| Parameters | Transmission Mode | Reflection Mode |
|---|---|---|
| Twist angle of LC | 60° | 60° |
| Δ nd of LC | 400 nm | 270 nm |
| slow axis angle of upper | 10° | 10° |
| retardation plate | | |
| Δ nd of upper retardation | 420 nm | 420 nm |
| plate | | |
| transmission axis angle of | 0° | 0° |
| upper polarization plate | | |
| slow axis angle of lower | 140° | N/A |
| retardation plate | | |
| Δ nd of lower retardation | 210 nm | N/A |
| plate | | |
| transmission axis angle of | 80° | N/A |
| lower polarization plate | | |

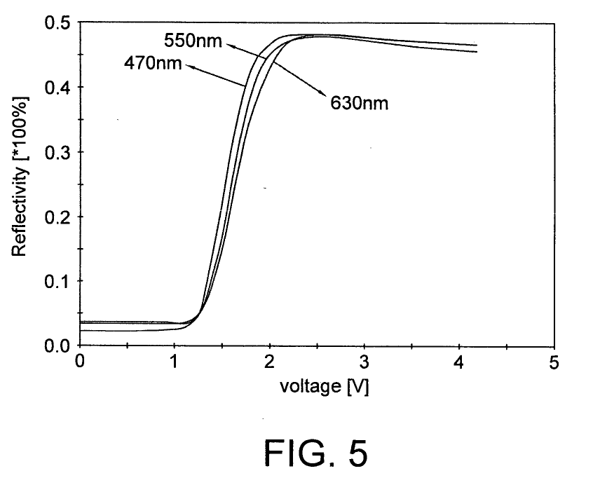

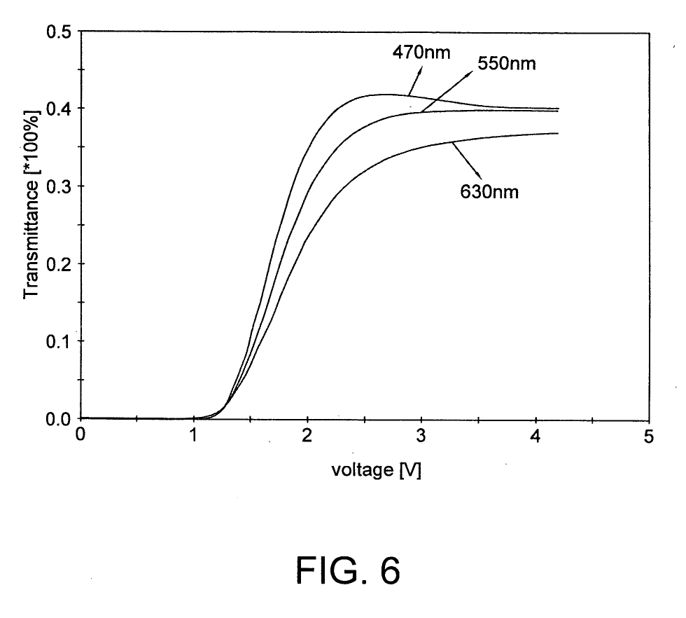

In this example, the reflectivity and transmittance of the transflective LCD device 100 at wavelengths 470 nm (Blue), 550 nm (Green) and 630 nm (Red) are calculated and shown in FIG. 5 and FIG. 6, respectively. In addition, the transmission contrast ratio is calculated as 397, and the reflection contrast ratio is calculated as 16.5.

### EXAMPLE 3

The simulation in this example calculates the reflectivity and transmittance, in relation to a voltage, of the transflective LCD device 100 in the reflection and transmission modes while the liquid crystal (LC) of the liquid crystal layer 106 has a twist angle of 70°, a phase delay value (Δnd) of 400 nm in the transmissive region 116, and a phase delay value (Δnd) of 270 nm in the reflective region 118. The simulation parameters are shown in Table 3.

TABLE 3
simulation parameters

| | Mode | |
|---|---|---|
| Parameters | Transmission Mode | Reflection Mode |
| Twist angle of LC | 70° | 70° |
| Δ nd of LC | 400 nm | 270 nm |
| slow axis angle of upper | 20° | 20° |
| retardation plate | | |
| Δ nd of upper retardation | 190 nm | 190 nm |
| plate | | |
| transmission axis angle of | 30° | 30° |
| upper polarization plate | | |
| slow axis angle of lower | 160° | N/A |
| retardation plate | | |
| Δ nd of lower retardation | 230 nm | N/A |
| plate | | |
| transmission axis angle of | 120° | N/A |
| lower polarization plate | | |

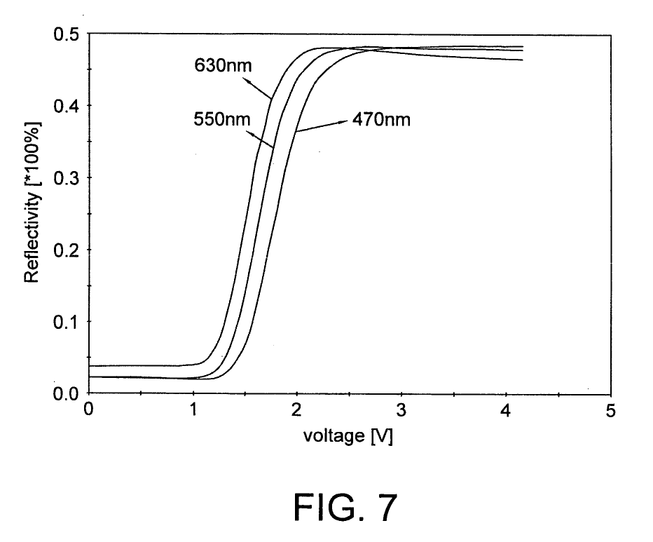

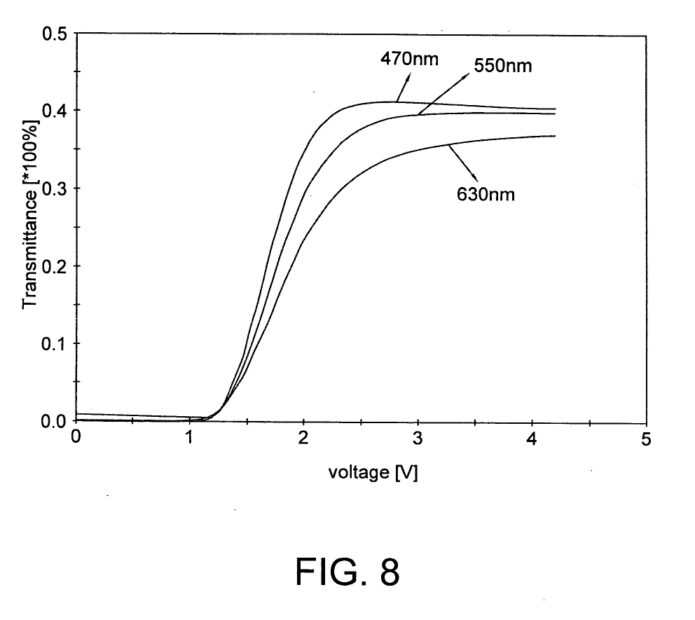

In this example, the reflectivity and transmittance of the transflective LCD device 100 at wavelengths 470 nm (Blue), 550 nm (Green) and 630 nm (Red) are calculated and shown in FIG. 7 and FIG. 8, respectively. In addition, the transmission contrast ratio is calculated as 381, and the reflection contrast ratio is calculated as 17.9.

### EXAMPLE 4

The simulation in this example calculates the reflectivity and transmittance, in relation to a voltage, of the transflective LCD device 100 in the reflection and transmission modes while the liquid crystal (LC) of the liquid crystal layer 106 has a twist angle of 80°, a phase delay value (Δnd) of 400 nm in the transmissive region 116, and a phase delay value (Δnd) of 270 nm in the reflective region 118. The simulation parameters are shown in Table 4.

TABLE 4
simulation parameters

| | Mode | |
|---|---|---|
| Parameters | Transmission Mode | Reflection Mode |
| Twist angle of LC | 80° | 80° |
| Δ nd of LC | 400 nm | 270 nm |
| slow axis angle of upper | 20° | 20° |
| retardation plate | | |
| Δ nd of upper retardation | 290 nm | 290 nm |
| plate | | |
| transmission axis angle of | 110° | 110° |
| upper polarization plate | | |
| slow axis angle of lower | 160° | N/A |
| retardation plate | | |
| Δ nd of lower retardation | 220 nm | N/A |
| plate | | |
| transmission axis angle of | 30° | N/A |
| lower polarization plate | | |

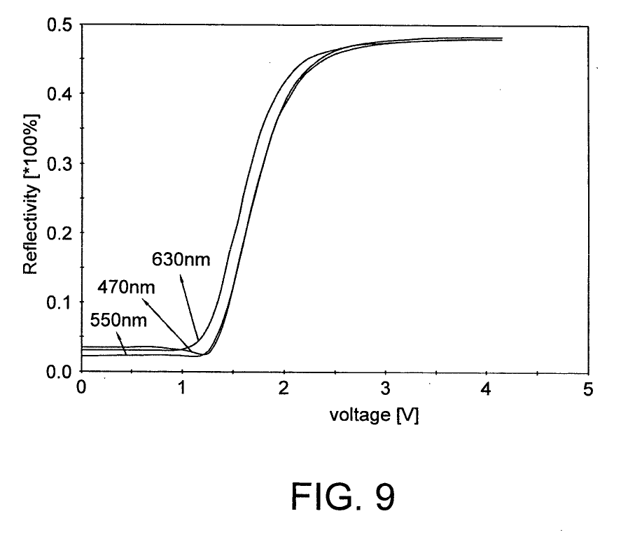

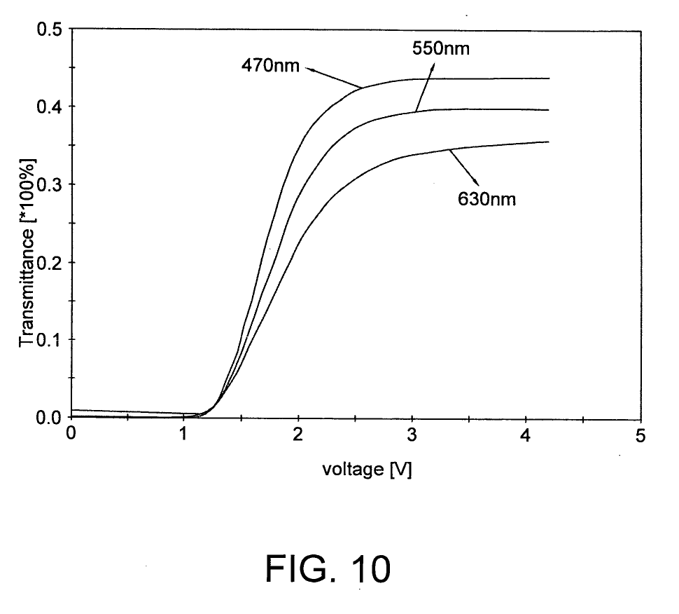

In this example, the reflectivity and transmittance of the transflective LCD device 100 at wavelengths 470 nm (Blue), 550 nm (Green) and 630 nm (Red) are calculated and shown in FIG. 9 and FIG. 10, respectively. In addition, the transmission contrast ratio is calculated as 309, and the reflection contrast ratio is calculated as 18.

As shown in FIGS. 4 to 10, it can be seen that the transflective LCD device 100 can display an image with high contrast ratio and low color dispersion by only utilizing two non-quarter wave plate, i.e. the upper retardation plate 108 and the lower retardation plate 112. Especially, the reflection contrast ratio of the transflective LCD device 100 is greater than 16. It also can be seen that transflective LCD device 100 stays in normally black mode while voltage is off. In addition, since only two retardation plates are utilized, the whole thickness and the manufacturing cost of the transflective LCD device 100 can be reduced; further, the optical plate disposing processes for the transflective LCD device 100 can also be simplified.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A dual-cell gap transflective LCD device, comprising:
an upper substrate and a lower substrate;
a liquid crystal layer formed of liquid crystal interposed between the upper and lower substrates;
a transmissive region and a reflective region defined on the lower substrate;
an upper polarization plate;
only an upper retardation plate disposed between the upper substrate and the upper polarization plate, wherein the upper retardation plate is a non-quarter wave plate;
a lower polarization plate; and
only a lower retardation plate disposed between the lower substrate and the lower polarization plate, wherein the lower retardation plate is a non-quarter wave plate;
wherein the liquid crystal layer has a phase delay value (Δnd) of 390 nm to 410 nm in the transmissive region.

2. The dual-cell gap transflective LCD device as claimed in claim 1, wherein the liquid crystal is mixed-mode twisted nematic liquid crystal having a twist angle of 50° to 80′.

3. The dual-cell gap transflective LCD device as claimed in claim 1, wherein the upper polarization plate has a transmission axis angle of 0° to 120°.

4. The dual-cell gap transflective LCD device as claimed in claim 1, wherein the upper retardation plate has a slow axis angle 0° to 30° and a phase delay value (Δnd) of 150 nm to 450 nm.

5. The dual-cell gap transflective LCD device as claimed in claim 1, wherein the lower polarization plate has a transmission axis angle of 20° to 180°.

6. The dual-cell gap transflective LCD device as claimed in claim 1, wherein the lower retardation plate has a slow axis angle 130° to 180° and a phase delay value (Δnd) of 200 nm to 250 nm.

7. A dual-cell gap transflective LCD device, comprising:
an upper substrate and a lower substrate;
a liquid crystal layer formed of liquid crystal interposed between the upper and lower substrates;
a transmissive region and a reflective region defined on the lower substrate;
an upper polarization plate;
only an upper retardation plate disposed between the upper substrate and the upper polarization plate, wherein the upper retardation plate is a non-quarter wave plate;
a lower polarization plate; and
only a lower retardation plate disposed between the lower substrate and the lower polarization plate, wherein the lower retardation plate is a non-quarter wave plate;
wherein the liquid crystal layer has a phase delay value (Δnd) of 260 nm to 280 nm in the reflective region.

8. The dual-cell gap transflective LCD device as claimed in claim 7, wherein the liquid crystal is mixed-mode twisted nematic liquid crystal having a twist angle of 50 to 80°.

9. The dual-cell gap transflective LCD device as claimed in claim 7, wherein the upper polarization plate has a transmission axis angle of 0° to 120°.

10. The dual-cell gap transflective LCD device as claimed in claim 7, wherein the upper retardation plate has a slow axis angle 0° to 30 and a phase delay value (Δnd) of 150 nm to 450 nm.

11. The dual-cell gap transflective LCD device as claimed in claim 7, wherein the lower polarization plate has a transmission axis angle of 20 to 180°.

12. The dual-cell gap transflective LCD device as claimed in claim 7, wherein the lower retardation plate has a slow axis angle 130° to 180° and a phase delay value (Δnd) of 200 nm to 250 nm.

13. A dual-cell gap transflective LCD device, comprising:
an upper substrate and a lower substrate;
a liquid crystal layer formed of liquid crystal interposed between the upper and lower substrates;
a transmissive region and a reflective region defined on the lower substrate;
an upper polarization plate;
an upper retardation plate disposed between the upper substrate and the upper polarization plate, wherein the upper retardation plate has a slow axis angle of 0° to 30° and a phase delay value (Δnd) of 150 nm to 450 nm;
a lower polarization plate; and
a lower retardation plate disposed between the lower substrate and the lower polarization plate, wherein the lower retardation plate has a slow axis angle of 130° to 180° and a phase delay value (Δnd) of 200 nm to 250 nm.

14. The dual-cell gap transflective LCD device as claimed in claim 13, wherein the liquid crystal is mixed-mode twisted nematic liquid crystal having a twist angle of 50° to 80°.

15. The dual-cell gap transflective LCD device as claimed in claim 14, wherein the liquid crystal layer has a phase delay value (Δnd) of 390 nm to 410 nm in the transmissive region.

16. The dual-cell gap transflective LCD device as claimed in claim 14, wherein the liquid crystal layer has a phase delay value (Δnd) of 260 nm to 280 nm in the reflective region.

17. The dual-cell gap transflective LCD device as claimed in claim 13, wherein the upper polarization plate has a transmission axis angle of 0° to 120°.

18. The dual-cell gap transflective LCD device as claimed in claim 13, wherein the lower polarization plate has a transmission axis angle of 20° to 180°.
